(19) United States
(12) Patent Application Publication
(10) Pub. No.: US 2004/0054595 A1
(43) Pub. Date: Mar. 18, 2004

(54) Electronic payment system for public transportation

(76) Inventor: Linda Din, Taichung Hsien (TW)

Correspondence Address: VENABLE, BAETJER, HOWARD AND CIVILETTI, LLP, P.O. BOX 34385, WASHINGTON, DC, 20043-9998, US

(21) Appl. No.: 10/245,399

(22) Filed: Sep. 18, 2002

(51) Int. Cl. G06F 17/60

(52) U.S. Cl. 705/21

(57) ABSTRACT

An electronic payment system includes an electronic card which is able to store therein information, a main frame installed in a transportation vehicle and having a sensing antenna to sense the information inside the electronic card and to link a read-write module, wherein the read-write module is connected to an encryption module so that the encryption module is able to receive and transmit information safely, and a control center connected to the main frame via radio to encode and decode information coming from the main frame so that every piece of information sending out of the control center is protected.

### BACKGROUND OF THE INVENTION

1. Field of the Invention

The present invention relates to an electronic payment system, and more particularly to an electronic payment system used in public transportation vehicles.

2. Description of Related Art

Faster, easier and more convenient in life are the advantages as a result from modern technology. When a user is using public transportation system, e.g. public transit system and buses, normally, the user is used to pay for the fee via a “smart card”, which has credits stored inside the smart card. Whenever the user is using the public transportation and paying the fee, the public transportation deducts the credits directly from the smart card so as to achieve the purpose of easy and convenient use. However, the user will have to purchase the smart card first by paper bills for a specific amount of credits and then the credits is gradually deducted everytime the user is paying the fee. When the credits in the smart card is insufficient for paying the fee, the card is useless or the user will have to accumulate a number of these “useless” cards to as to change for a new one. Because this kind of payment mechanism is not efficient, another payment system is invented by paying the fee via credit card. Using credit card to pay the fee is indeed able to avoid the inconvenience of “left-over” credits, however, everytime when the user is using the credit card, the conductor or the driver will have to communicate with the financial center to have the authorization code to confirm whether the credit card is valid and whether the transaction is successful. The communication with the financial center actually causes unnecessary burden to the public transportation business. Furthermore, the constant contact of the credit card to the card reader will cause damage to the magnetic bar on the credit card, which leads to the credit card invalid.

To overcome the shortcomings, the present invention tends to provide an improved payment system to mitigate and obviate the aforementioned problems.

### SUMMARY OF THE INVENTION

The primary objective of the present invention is to provide an improved payment system having the advantages of both the smart card and the credit card.

In order to accomplish the foregoing objective, the payment system of the present invention has:

an electronic card with information of an individual;

a main frame installed in a transportation vehicle and having a sensing antenna to sense the information inside the electronic card and to link a read-write module, wherein the read-write module is connected to an encryption module so that the encryption module is able to receive and transmit information; and

a control center connected to the main frame via radio to encode and decode information coming from the main frame so that every piece of information sending out of the control center is protected.

Other objects, advantages and novel features of the invention will become more apparent from the following detailed description when taken in conjunction with the accompanying drawings.

### BRIEF DESCRIPTION OF THE DRAWINGS

FIG. 1 is a schematic view showing the arrangement of the system of the present invention; and

FIG. 2 is a schematic flow chart showing the operation of the payment mechanism of the present invention.

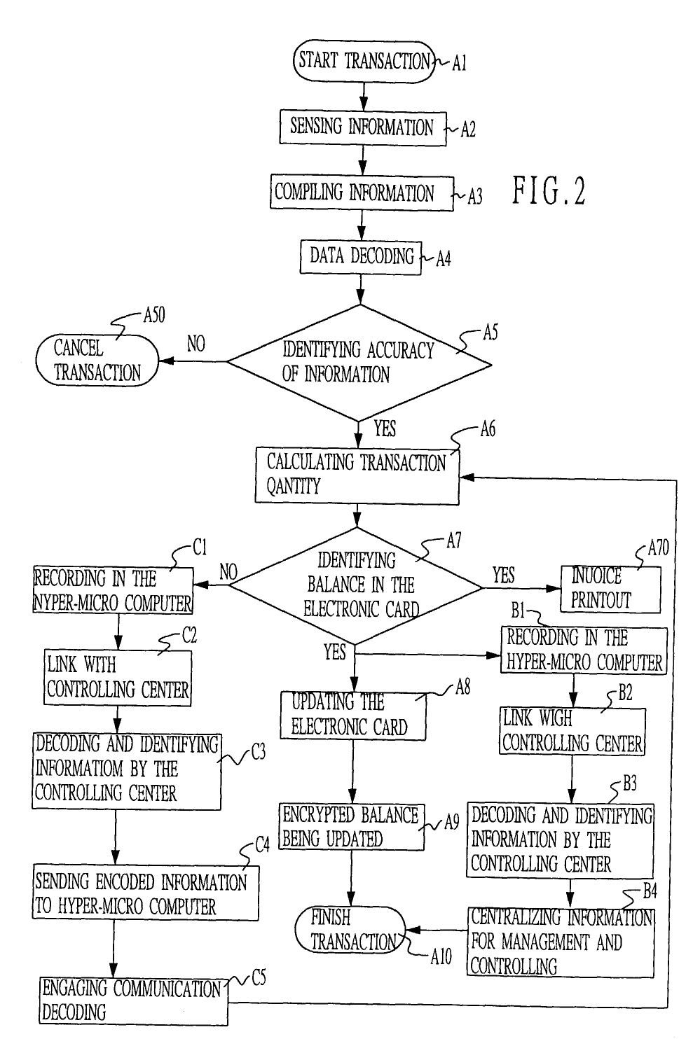

### DETAILED DESCRIPTION OF THE PREFERRED EMBODIMENT

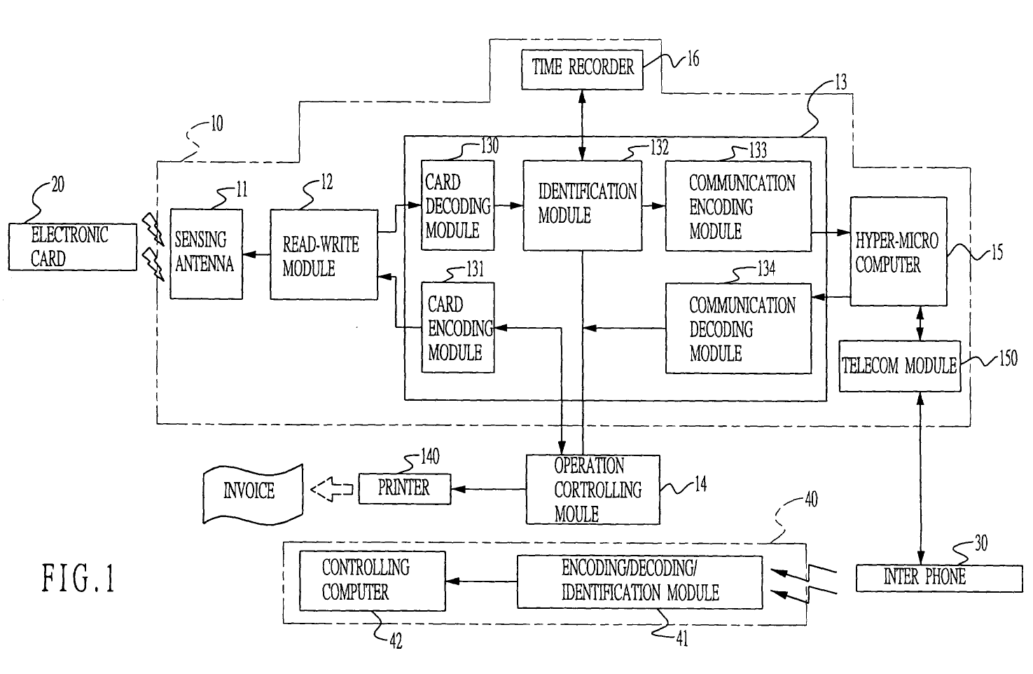

With reference to FIG. 1, the electronic payment system for use with public transportation vehicles includes an electronic card (20) which is able to store therein information, a main frame (10) installed in a transportation vehicle and having a sensing antenna (11) to sense the information inside the electronic card (20) and to link a read-write module (12), wherein the read-write module (12) is connected to an encryption module (13) so that the encryption module (13) is able to receive and transmit information safely, and a control center (40) connected to the main frame (10) via radio to encode and decode information coming from the main frame (10) so that every piece of information sending out of the control center (40) is protected.

To be more specific, the encryption module (13) is then connected to an operation controlling module (14), a hyper-micro computer (15) and a time recorder (16) to record the transaction time.

The encryption module (13) includes a card decoding module (130), a card encoding module (131), an identification module (132) and communication encoding/decoding modules (133,134). The read-write module (12) outside the encryption module (13) has an output port connected to the card decoding module (130) and the card decoding module (130) is connected to the identification module (132). The identification module (132) is respectively connected to the communication encoding module (133) and the operation controlling module (14) outside the encryption module (13). The operation controlling module (14) is then connected to a printer (140) so as to form a first and a second output port with the hyper-micro computer (15) which is connected to the output port of the communication encoding module (133). The first output port is connected to the communication decoding module (134) which, in turn, connects to the operation controlling module (14) so that the output port of the operation controlling module (14) is connected to the card encoding module (131) in the encryption module (13). The card encoding module (131) is then connected to the read-write module (12). Thereafter, the sensing antenna (11) is able to send out encrypted information from the main frame (10) to update the information inside the electronic card (20).

Further, the hyper-micro computer (15) is connected to a telecom module (150) so as to enable the main frame (10) to communicate with a inter phone (30) remote from the main frame (10). The inter phone (30) is able to establish communication with the control center (40). The control center (40) has an encoding/decoding/identification module (41) connected to a controlling computer (42) inside the control center (40).

When implemented, the main frame (10) is able to be installed inside a public transportation vehicle, such as buses, trains or even taxies and the payment system of the present invention is able to proceed according to the following steps:

A1: start transaction;

A2: sensing information, wherein a link is established between the sensing antenna (11) and the electronic card (20) so that the sensing antenna (11) is able to retrieve data inside the electronic card (20);

A3: compiling information, wherein the sensed data is encrypted by the read-write module (12);

A4: data decoding, wherein the card decoding module (130) of the encryption module (13) is able to decode the encrypted data to form information;

A5: identifying accuracy of information, wherein the identification module (132) identifies the decoded information and if the information is confirmed to be invalid, the following route turns to step A50 to cancel transaction, and if the information is confirmed to be valid, the following route turns to step A6;

A6: calculating transaction quantity, wherein after identification, the operation controlling module (14) calculates the transaction quantity and the time recorder (16) records the transaction time;

A7: identifying balance in the electronic card, wherein the transaction quantity from the operation controlling module (14) is compared with the decoded information in the electronic card (20) to see if the balance in the electronic card (20) is enough, if yes, the following step splits simultaneously to two routes which includes:

A70: invoice printout, wherein after step A7, the printer (140) prints out the transaction result to complete the transaction;

A8: updating the electronic card with the updated balance, wherein after step A7, the new balance is sent to the card encoding module (131) of the encryption module (13) to proceed the balance encrypting (encoding) process;

A9: updating the electronic card, wherein the encrypted balance is first compiled by the read-write module (12) and then is sent to the electronic card (20) by the sensing antenna (11) to update the information in the electronic card (20);

B1: transaction recording in the hyper-micro computer, wherein after step A7, the transaction activity is stored in the hyper-micro computer (15);

B2: linking with the control center, wherein after the records in hyper-micro computer (15) reach a specific amount or a specific time period, the telecom module (150) of the main frame (10) controls the inter phone (30) to link the control center (40) and then sends the encrypted information to the control center (40);

B3: decoding and identifying information by the control center, wherein the information sent to the control center (40) is decoded and identified by the encoding/decoding/identification module (41);

B4: managing and controlling the decoded information from the encoding/decoding/identification module (41) by the controlling computer (42) so as to complete the transaction;

After step A7, if the balance in the electronic card (20) is not enough, the following steps includes:

C1: recording in the hyper-micro computer, wherein the transaction quantity is encoded by the communication encoding module (133) and stored by the hyper-micro computer;

C2: linking with the control center, wherein the stored and encoded transaction information is sent to the control center (40) periodically by the telecommodule (150) to control the inter phone (30) to establish link with the control center (40)

C3: decoding and identifying information by the control center, wherein the information sent to the control center (40) is decoded and identified by the encoding/decoding/identification module (41);

C4: sending encoded information to hyper-micro computer, wherein after the control center (40) sends out the credit authorization code, the encoding/decoding/identification module (41) proceeds the information encoding process and then the encoded information is returned to the hyper-micro computer (15) by the telecom module (150);

C5: engaging communication decoding, wherein after the hyper-micro computer (15) receives the encoded authorization code from the control center (40), the encoded authorization code is sent to the communication decoding module (134) to proceed decoding process and then the decoded authorization code is sent to the operation controlling module (14) to complete credit authorization; thereafter, steps A7 to A10 are repeated to complete the transaction.

From the foregoing description, the present invention has the following advantages:

1. Easy in transaction: because the electronic card (20) is able to have the function as a credit card via the processes of communication encoding and decoding;

2. Secure safety of transaction: details of every transaction is recorded by the main frame (10) so that not only all the personnel involved in the transaction is able to search for a specific piece of information if there is any doubt, but also crimes such as money stealing is prevented;

3. Fast data reading: the data in the card is retrieved by a sensing antenna (11) and is stored into the card by the read-write module (12) so that the electronic card (20) is not easy to be damaged and is able to be preserved for a long time.

It is noted that if a card holder is using the electronic card to take a cab, after the foregoing process, the control center (40) is able to send the final information to the cab dispatch center (the accounting department) so that the cab dispatch center is able to learn how much the cab fare is and thus requests payment of the same amount from the related bank.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electronic payment system for public transportation comprising:
an electronic card which is able to store therein information;
a main frame installed in a transportation vehicle and having a sensing antenna to sense the information inside the electronic card, a read-write module which is connected to an encryption module so that the encryption module is able to receive and transmit the information safely, an operation controlling module connected to the read-write module via the encryption module and a hyper-micro computer connected to the encryption module and having a telecommodule,
whereby the operation controlling module is able to proceed identification and updating the information in the electronic card and the hyper-micro computer is able to connect to a control center to have a transaction authorization.

2. The electronic payment system as claimed in claim 1, wherein the control center has an encoding/decoding/identification module which is connected to a controlling computer inside the control center.

3. The electronic payment system as claimed in claim 1, wherein the encryption module includes a card decoding module, a card encoding module, an identification module and communication encoding/decoding modules, wherein the read-write module outside the encryption module has an output port connected to the card decoding module and the card decoding module is connected to the identification module, the identification module is respectively connected to the communication encoding module and the operation controlling module outside the encryption module.

4. The electronic payment system as claimed in claim 3, wherein the hyper-micro computer has two output ports one of which is connected to the communication decoding module which connects to the operation controlling module so that an output port of the operation controlling module is connected to the card encoding module in the encryption module, the card encoding module is then connected to the read-write module, the sensing antenna is able to send out encrypted information from the main frame to update the information inside the electronic card.

5. The electronic payment system as claimed in claim 1 further comprising a time recorder connected to the main frame to record transaction time.

6. The electronic payment system as claimed in claim 3 further comprising a time recorder connected to the main frame to record transaction time.

7. The electronic payment system as claimed in claim 4 further comprising a time recorder connected to the main frame to record transaction time.

8. The electronic payment system as claimed in claim 1, wherein the operation controlling module further has a printer.

9. The electronic payment system as claimed in claim 3, wherein the operation controlling module further has a printer.

10. The electronic payment system as claimed in claim 4, wherein the operation controlling module further has a printer.

11. The electronic payment system as claimed in claim 6, wherein the operation controlling module further has a printer.

12. The electronic payment system as claimed in claim 7, wherein the operation controlling module further has a printer.
